(19) United States
(12) Patent Application Publication
(10) Pub. No.: US 2018/0257228 A1
(43) Pub. Date: Sep. 13, 2018

(54) SYSTEMS AND METHODS FOR ROBOTIC ASSISTANCE WITH RETAIL LOCATION MONITORING

(71) Applicant: Walmart Apollo, LLC, Bentonville, AR (US)

(72) Inventors: Jeremy Tingler, BENTONVILLE, AR (US); Alvin Scott Taulbee, Springdale, AR (US); Steven Lewis, Bentonville, AR (US)

(21) Appl. No.: 15/916,663

(22) Filed: Mar. 9, 2018

Related U.S. Application Data
(60) Provisional application No. 62/469,739, filed on Mar. 10, 2017.

(51) Int. Cl. B25J 9/16

(52) U.S. Cl. CPC B25J 9/1661; B25J 9/1669

(57) ABSTRACT

Embodiments relate to systems and methods for managing an autonomous robot in a retail environment. A system for managing an autonomous robot in a retail environment generally includes an external vendor robot task request system, a retailer robot task scheduling system, and an autonomous robot located in the retail environment. The retailer robot task scheduling system receives an external vendor robot task request from the external vendor robot task request system, combines the external vendor robot task request and an internal retailer-defined task into a robot task list, and communicates the robot task list to the autonomous robot.

### RELATED APPLICATION

The present application claims the benefit of U.S. Provisional Application No. 62/469,739 filed Mar. 10, 2017, which is hereby incorporated herein in its entirety by reference.

### TECHNICAL FIELD

Embodiments relate generally to retail location monitoring and more particularly to systems and methods for robotic assistance of retail location monitoring.

### BACKGROUND

Vendors of products offered for sale by retailers often wish to check their products at the retailer's store. For example, vendors may want to confirm that a product modular or display has been set up properly or is placed in a particular location within the store, or confirm that promotional pricing or offers are being made as directed. Currently, vendors send vendor personnel or hire contractors to physically visit retail locations for visual or photographic inspection of the vendor's products and displays. This is expensive and time-consuming.

Simultaneously, many retailers have begun to use autonomous robots in their stores to carry out various tasks for the retailer. Therefore, there is a need for systems and methods to integrate and manage retailer robots for vendor-associated monitoring.

### SUMMARY

In an embodiment, a system for managing an autonomous robot in a retail environment comprises an external vendor robot task request system comprising a user interface configured to accept an external vendor robot task request having a task definition and a desired task timeframe and present a price for the external vendor robot task request related to at least one of the task definition, the desired task timeframe, or an existing robot task list; and a retailer robot task scheduling system configured to: receive at least one internal retailer-defined task having a task definition and a task timeframe and add the at least one internal retailer-defined task to the existing robot task list according to the task timeframe, receive the external vendor robot task request after the presented price for the external vendor robot task request has been accepted and update the existing robot task list to include an external vendor robot task based on the external vendor robot task request, wherein the updated robot task list is sorted according to at least one of task definitions, desired task timeframes, price, or at least one task already on the existing robot task list, and communicate the updated robot task list; and an autonomous robot located in the retail environment and configured to receive the communicated updated robot task list and provide a confirmation once the external vendor robot task is completed.

In an embodiment, a method for managing an autonomous robot in a retail environment comprises receiving an external vendor robot task request having a task definition and a desired task timeframe; presenting a price for the external vendor robot task request related to at least one of the task definition, the desired task timeframe, or an existing robot task list; updating the existing robot task list by adding an external vendor robot task based on the external vendor robot task request according to at least one of the task definition, the desired task timeframe, or at least one task already on the existing robot task list; communicating the updated robot task list to an autonomous robot in the retail environment; and providing a confirmation by the autonomous robot once the external vendor robot task is completed.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for managing an autonomous robot in a retail environment, according to an embodiment.

FIG. 2A is a block diagram of a robot task list including a plurality of retailer tasks, according to an embodiment.

FIG. 2B is a block diagram of a robot task list including a plurality of retailer tasks and a vendor task, according to an embodiment.

FIG. 3 is a block diagram of a primary task queue and a downtime task queue for a robot task list, according to an embodiment.

FIG. 4 is a diagram of a retail store in which in which components of the system of FIG. 1 can be deployed, according to an embodiment.

FIG. 5 is a flowchart of a method for managing an autonomous robot in a retail environment, according to an embodiment.

FIG. 6 is a flowchart of a method for analyzing a robot task list for an autonomous robot in a retail environment, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

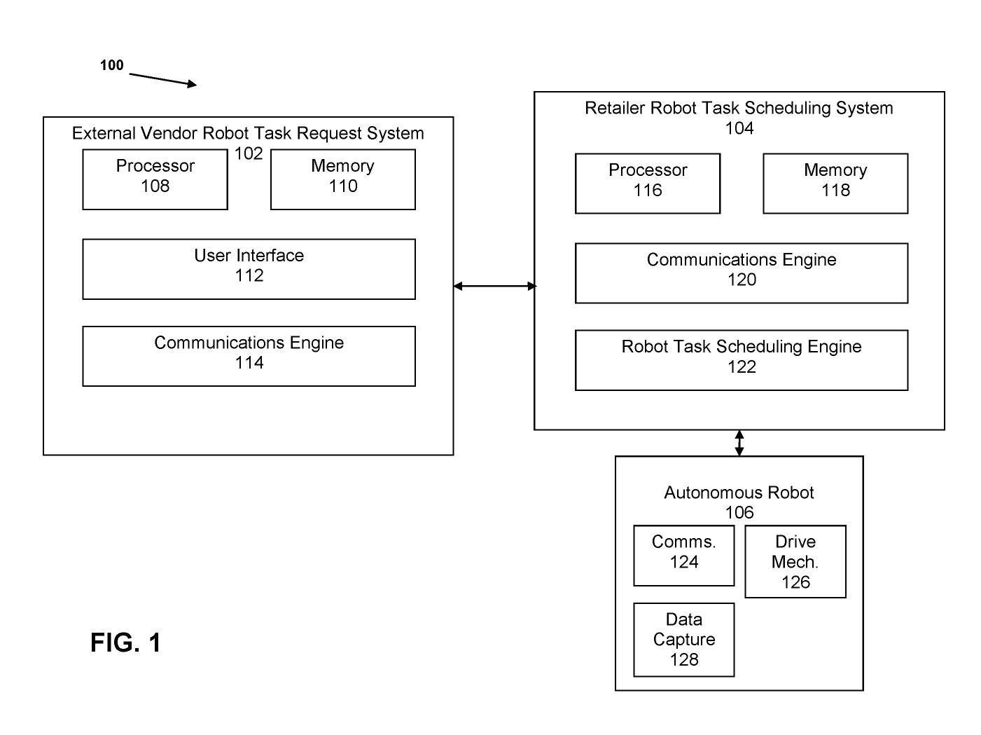

Referring to FIG. 1, a system 100 for managing an autonomous robot in a retail environment is depicted, according to an embodiment. System 100 generally comprises an external vendor robot task request system 102, a retailer robot task scheduling system 104, and an autonomous robot 106.

Embodiments of system 100 can be performed in cloud computing, client-server, or other networked environment, or any combination thereof. The components of system 100 can be located in a singular “cloud” or network, or spread among many clouds or networks. End-user knowledge of the physical location and configuration of components of system 100 is not required.

As will be described, system 100 and/or its components or subsystems can include computing devices, microprocessors, modules and other computer or computing devices, which can be any programmable device that accepts digital data as input, is configured to process the input according to instructions or algorithms, and provides results as outputs. In an embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the invention.

In embodiments, the system or components thereof can comprise or include various modules or engines, each of which is constructed, programmed, configured, or otherwise adapted, to autonomously carry out a function or set of functions. The term “engine” as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

External vendor robot task request system 102 generally comprises a processor 108, memory 110, a user interface 112, and a communications engine 114. One skilled in the art will appreciate that processor 108 and memory 110 can be utilized to implement user interface 112, and communications engine 114.

Processor 108 can be configured with program instructions to implement the particular functionality of external vendor robot task request system 102 in combination with operably coupled memory 110.

User interface 112 comprises an interactive graphical user interface (GUI). In an embodiment, user interface 112 comprises a web-based user interface of a series of web pages. In an embodiment, user interface 112 comprises a traditional desktop computing software GUI. In other embodiments, user interface 112 can comprise command-line, touchscreen, voice, command-line, or any other desktop computing, mobile device, or cloud-based computing interface.

User interface 112 can present log-on prompts for the various vendor users interfacing to external vendor robot task request system 102. Once a vendor user has been verified, vendor users can interact with user interface 112 to input an external vendor robot task request. In an embodiment, the external vendor robot task request comprises a task definition and a desired task timeframe in which the task is to be completed. For example, a task definition can include monitoring a particular display, or verifying a particular retail item pricing. A desired task timeframe can include, for example, “immediately,” “within one hour,” “within two hours,” “within one day,” “when least expensive,” and so on.

In further embodiments, user interface 112 is further configured to present a price for the external vendor robot task request. For example, vendors and retailers can negotiate different prices for robot tasks based on the task definition, the desired task timeframe, or how busy the robot is according to an existing robot task list.

For example, the existing robot task list can include a primary task queue and a downtime task queue. In embodiments, the autonomous robot is configured to carry out tasks in the downtime task queue when the primary task queue is completed or inactive. User interface 112 can present primary task queue options and downtime task queue options to the vendor for execution on the robot. User interface 112 allows for the addition of the external vendor robot task request to be assigned to the primary task queue or the downtime task queue. In an embodiment, user interface 112 can present a first price for adding the external vendor robot task to the downtime task queue and a second price higher than the first price for adding the external vendor robot task to the primary task queue.

In another embodiment, user interface 112 can present an external vendor robot task subscription offer to a vendor user, wherein the subscription offer comprises a price bundle for multiple external vendor robot tasks.

Pricing models can vary, according to embodiments. For example, a vendor user can be given time-based or task-based credits, pay by subscription, pay on-demand, or use some other scheme. Pricing also can be structured such that tasks to be carried out immediately are more expensive, whereas tasks that can be carried out when the robot has downtime or low demand are less expensive. In some embodiments, vendors can access real-time robot availability for a selected location in order to determine time and price selections.

These types of pricing offers and displays by user interface 112 are provided by way of example and are in no way meant to be limiting.

User interface 112 can present predefined robot task requests. For example, user interface 112 can present a set of predefined external vendor robot tasks to the vendor user, such as “Verify Pricing,” “Photograph My Modular,” and so on. Likewise, user interface 112 can present predefined task timeframes. User interface 112 can present a desired task timeframe to be selected by a vendor user according to the predefined task timeframes.

In an embodiment, messaging between external vendor robot task request system 102, retailer robot task scheduling system 104, and autonomous robot 106 can be conducted in real-time to provide a real-time status of autonomous robot 106. In other embodiments, a simulated real-time status can be provided using the task queue(s) of retailer robot task scheduling system 104 without actual communication from autonomous robot 106. Accordingly, user interface 112 can present real-time availability of autonomous robot 106 to a vendor user.

Communications engine 114 is configured to transmit the external vendor robot task request received at user interface 112 to retailer robot task scheduling system 104. Communications engine 114 is further configured to receive confirmations of task completions, which can be subsequently displayed to the user via user interface 112. In embodiments, communications engine 114 can comprise communications software and transceiver circuitry. Transmitter circuitry can comprise one or more electronic elements configured to transmit and receive data related to system 100. For example, wireless transceiver circuitry can be configured for radio frequency (RF) communications, WIFI communications, BLUETOOTH communications, cellular communications, or near-field communications (NFC). Wired transceiver circuitries can likewise be utilized, such as CAT-5 and CAT-6.

External vendor robot task request system 102 can further be configured to provide data security and privacy between vendor users and retailers. In an embodiment, user interface 112 is configured to hide or otherwise not display data related to other vendor users. For example, if a first vendor user is logged on to external vendor robot task request system 102, only the data related to the first vendor user is displayed. In embodiments, first vendor user is unaware of any other vendor tasks or retailer tasks queued or performed by autonomous robot 106. In certain embodiments, external vendor robot task request system 102 further comprises a memory management engine that is configured to partition memory 110. For example, a virtual partition or segmentation can be generated before a vendor user logs on with user interface 112. In other embodiments, a virtual partition or segmentation can be generated after a vendor user logs on. Such partitioning or segmenting further inhibits potential bad actors from accessing data on memory 110.

Retailer robot task scheduling system 104 generally comprises a processor 116, memory 118, a communications engine 120, and a robot task scheduling engine 122. One skilled in the art will appreciate that processor 116 and memory 118 can be utilized to implement communications engine 120 and robot task scheduling engine 122.

Processor 116 can be configured with program instructions to implement the particular functionality of retailer robot task scheduling system 104 in combination with operably coupled memory 118.

Communications engine 120 is configured to receive the external vendor robot task request from external vendor robot task request system 102, and particularly, communications engine 114. Accordingly, communications engine 120 can comprise communications software and transceiver circuitry as described above with respect to communications engine 114. For example, transmitter circuitry can comprise one or more electronic elements configured to transmit and receive data related to system 100. For example, wireless transceiver circuitry can be configured for radio frequency (RF) communications, WIFI communications, BLUETOOTH communications, cellular communications, or near-field communications (NFC). Wired transceiver circuitries can likewise be utilized, such as CAT-5 and CAT-6.

Communications engine 120 is further configured to transmit the updated robot task list to autonomous robot 106 and receive communications from autonomous robot 106. In embodiments, communications engine 120 can be further configured for the particular autonomous robot 106 of system 100 with robot-specific communications protocols and communications hardware.

Robot task scheduling engine 122 is configured to receive robot-related tasks and add the received tasks to a task list. In an embodiment, the task list can be stored in memory 118.

Robot task scheduling engine 122 is configured to receive internal retailer-defined tasks. As with external vendor-defined tasks, each internal retailer-defined task can include a task definition and a task timeframe. In an embodiment, internal retailers can enter tasks directly to robot task scheduling engine 122 (which can include a user interface for doing so). In other embodiments, internal retailers can utilize the interfaces established by external vendor robot task request system 102 to enter retailer tasks. In those embodiments, the retailer task can be received by robot task scheduling engine 122 via communications engine 120. Once received, the internal retailer-defined task can be added to the existing robot task list or queue. In an embodiment, internal retailer-defined task can be added according to the task timeframe.

Robot task scheduling engine 122 is further configured to receive an external vendor robot task request defined by the vendor user with external vendor robot task request system 102. Once received, the existing robot task list can be updated to include the external vendor robot task request.

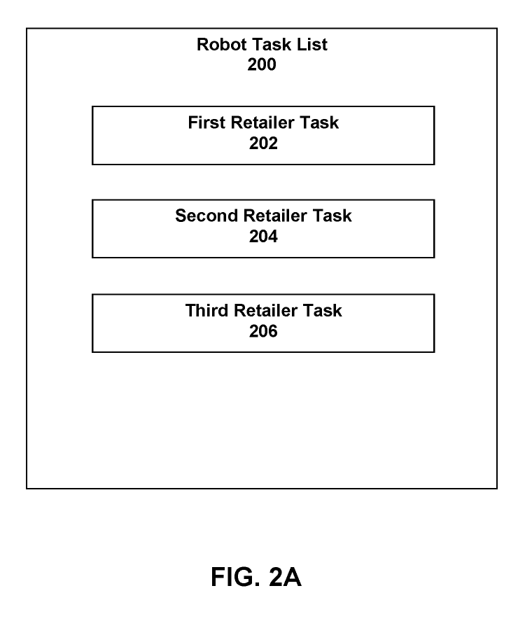

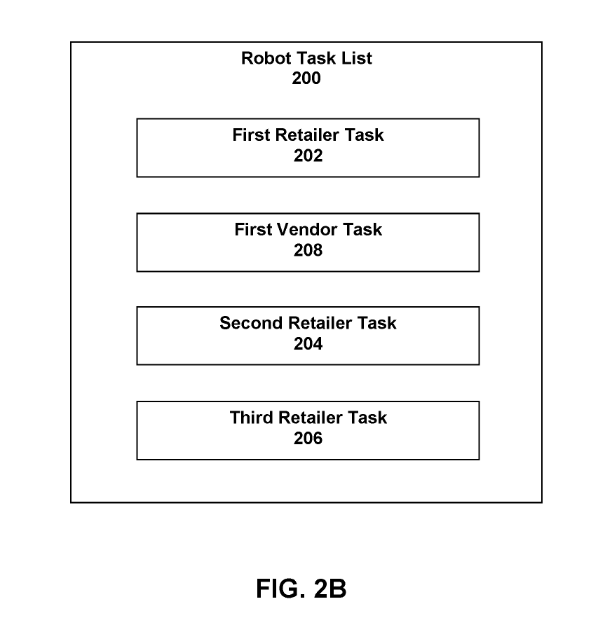

For example, referring to FIG. 2A, a block diagram of a robot task list 200 including a plurality of retailer tasks is depicted, according to an embodiment. Robot task list 200 is initially empty. However, once robot tasks are received by robot task scheduling engine 122, they can be added to robot task list 200. For example, as shown in FIG. 2A, three retailer tasks have been added to the robot task list 200. First retailer task 202 has been prioritized to be done first, second retailer task 204 has been prioritized to be done second, and third retailer task 206 has been prioritized to be done third. First retailer task 202, second retailer task 204, and third retailer task 206 can be transmitted to robot task scheduling engine 122 in any order. For example, third retailer task 206 can be transmitted to robot task scheduling engine 122 before first retailer task 202 or second retailer task 204, but if third retailer task 206 has the lowest priority, it is placed after the other tasks, once the other tasks are received and the list is sorted. However, in a first-in-first-out (FIFO) queue, first retailer task 202, second retailer task 204, and third retailer task 206 are received by robot task scheduling engine 122 in that order.

Referring to FIG. 2B, a block diagram of an updated robot task list including the plurality of retailer tasks of FIG. 2A and a vendor task is depicted, according to an embodiment. In FIG. 2B, first vendor task 208 has been received by robot task scheduling engine 122. Accordingly, first vendor task 208 is placed in the list according to the sorting criteria. In this case, first vendor task 208 is placed in the list to be done after first retailer task 202, but prior to second retailer task 204 and third retailer task 206. An updated robot task list is therefore generated by robot task scheduling engine 122.

The updated robot task list can be sorted according to any number of suitable criteria, including task definitions, desired task timeframes, price, or at least one task already on the existing robot task list. The updated robot task list can be sorted according to vendor-specified criteria (for example, as agreed upon in the vendor task request), or by retailer-based criteria (timing, task definition, etc.) In other embodiments, the updated robot task list can be sorted according to a mix of retailer-specific and vendor-specific criteria. For example, a vendor paying a certain additional fee to execute a task can be prioritized above all retailer tasks. In embodiments, weighting or scoring can be applied to prioritize tasks in the updated robot task list. In another example, additional weighting or priority can be given to special rights suppliers, such as very large client vendors, which can be prioritized over a relatively smaller client.

In embodiments, robot task scheduling engine 122 can be configured to control any number of robot instances. For example, in an implementation with a single robot operating in the store, robot task scheduling engine 122 can manage a single robot. In an implementation with multiple robots, robot task scheduling engine 122 can be relatively more centralized and in communication with more than one robot to coordinate the multiple robots. Robot task scheduling engine 122 can determine particular characteristics of the individual robots (e.g., sensor quality, battery life, speed, ground or air movement, etc.) to automatically prioritize which particular robot is appropriate for a given task. Robot task scheduling engine 122 also can use the particular characteristics of the individual robots to reassign tasks among robots if particular characteristic(s) of one or more of the robots are necessary to complete a task, such that other tasks can be reassigned to one or more other suitable robots.

For example, a store may have three robots: Robot A, which is capable of ground operation having a camera, Robot B, which is capable of ground operation having a temperature sensor, and Robot C, which is capable of flight and having a camera. At a given moment, Robot A has 90% battery remaining, Robot B has 25% battery remaining, and Robot C has 75% battery remaining. The tasks in robot task list 200 can be applied to any of the robots for the store based on these characteristics. Robot task scheduling engine 122 is configured to analyze the tasks in robot task list 200 and Robot A, Robot B, and Robot C characteristics to determine which tasks should be assigned to which robot and when the robot should execute the task.

For example, robot task scheduling engine 122 can assign a ground-based task in a certain area to Robot A that requires a camera and will take less than the 90% battery remaining for that robot. In embodiments, Robot A can also be in the area of the task and therefore, additional weight is given to Robot A when assigning robots to the tasks.

In another example, robot task scheduling engine 122 can assign a flight-based task to Robot C. For example, if a vendor task includes taking a higher elevation picture, flying Robot C can be assigned that task.

In another example, a task can include taking a high resolution image. For example, a vendor can pay more for a high resolution image compared to standard image definition. Robot task scheduling engine 122 can determine the relative camera quality between Robot A and Robot C (ignoring Robot B, which does not have a camera), and assign the task to the robot with the higher quality camera.

In an embodiment, if Robot B will otherwise be idle, and given its relatively low battery life, robot task scheduling engine 122 command Robot B to travel to a charging station to charge the battery. In an embodiment, Robot B can be assigned a task that can be completed within its battery life on the way to the charging station.

In an embodiment, robot task scheduling engine 122 is further configured to communicate or transmit the updated robot task list. For example, robot task scheduling engine 122 can communicate the updated robot task list to autonomous robot 106 or personnel of the retail environment.

In an embodiment, robot task scheduling engine 122 is further configured to analyze the current robot task list. Robot task scheduling engine 122 can analyze current tasks in the list to determine the external vendor robot task timeframes that are presented to vendor users of external vendor robot task request system 102. For example, if a vendor wants the least expensive price for a task and will take the queue spot after all current tasks are completed, robot task scheduling engine 122 can determine a projected time to complete all current tasks in the list. In a particular example, robot task scheduling engine 122 can analyze the existing robot task list and offer a predefined external vendor robot task timeframe to external vendor robot task request system 102 based on a result of the analysis being that autonomous robot 106 can carry out the requested external vendor task in coordination with an internal retailer-defined task already on the existing robot task list.

In still other embodiments, robot task scheduling engine 122 can coordinate tasks based on the relative location of the task to another task within in the store. For example, robot task scheduling engine 122 is configured to determine that autonomous robot 106 can carry out the requested external vendor task in coordination with the internal retailer-defined task already on the existing robot task list if the requested external vendor task is in an area of the retail environment that is the same as or proximate to an area of the retail environment of the internal retailer-defined task already on the existing robot task list.

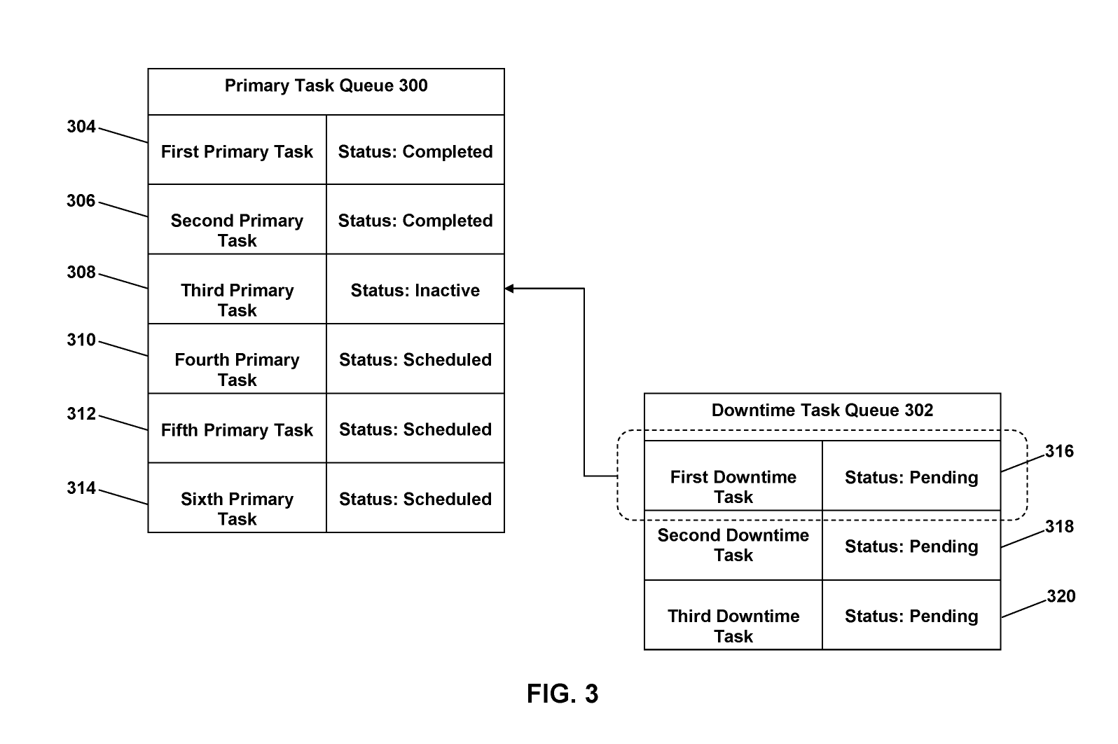

As mentioned above, the robot task list can include a primary task queue and a downtime task queue. Robot task scheduling engine 122 can command autonomous robot 106 to carry out tasks in the downtime task queue when the primary task queue is completed or inactive. For example, referring to FIG. 3, a block diagram of a primary task queue 300 and a downtime task queue 302 for a robot task list are depicted, according to an embodiment.

Primary task queue 300 comprises a set of tasks and a status for each of the tasks. In embodiments, each task entry can include a task definition and a desired task timeframe. The tasks define the primary responsibilities of the autonomous robot to which they are linked.

In an embodiment, first primary task 304 has a status of “Completed.” Second primary task 306 has a status of “Completed.” Third primary task 308 has a status of “Inactive.” Fourth primary task 310 has a status of “Scheduled.” Fifth primary task 312 has a status of “Scheduled.” Sixth primary task 314 has a status of “Scheduled.” Status entries are given by way of example, as “Completed” indicates that the task has been performed by an autonomous robot, “Inactive” indicates that the task cannot be performed, or cannot be performed as scheduled, and “Scheduled” indicates that the task is in the queue but has not yet been performed. In an embodiment, tasks having a “Completed” or “Inactive” status can be appended with downtime tasks. For example, if first primary task 304 or second primary task 306 are completed earlier than scheduled, tasks from downtime task queue 302 can be inserted into those time slots. Likewise, because third primary task 308 is “Inactive,” tasks from downtime task queue 302 can be inserted into the third primary task 308 time slot.

Downtime task queue 302 comprises a set of tasks and a status for each of the tasks. In embodiments, each task entry can include a task definition and a desired task timeframe. The tasks define the secondary (downtime) responsibilities of the autonomous robot to which they are linked.

In an embodiment, first downtime task 316 has a status of “Pending” indicating that it is ready to be inserted into primary task queue 300, should a time slot open up. Likewise, second downtime task 318 and third downtime task 320 also have statuses of “Pending.”

The tasks in downtime task queue 302 can be ordered according to relative importance or timing considerations similar to primary task queue 300. In embodiments, the tasks in downtime task queue 302 can be ordered based on the consideration of their relative dependence on tasks in primary task queue 300. For example, location-based algorithms can be performed on the tasks of both primary task queue 300 and downtime task queue 302 to determine which of the tasks are to be completed in relative similar locations within the store. Those tasks can be linked between primary task queue 300 and downtime task queue 302. Accordingly, tasks in downtime task queue 302 can then be prioritized based on the time slot that opens in primary task queue 300. For example, first downtime task 316 can be “first” in line to be executed should a time slot open in primary task queue 300. However, if second downtime task 318 is to be executed in a similar location to the primary task that the robot just complete (i.e. the robot is already in a location relatively close to the required downtime task 318 location), second downtime task 318 can be prioritized over first downtime task 316. Location information can therefore also be stored with the task data.

In another example, timing-based algorithms can be performed on the tasks of both primary task queue 300 and downtime task queue 302 to determine which of the tasks in downtime task queue 302 can be completed relative to the scheduled timings of the tasks in primary task queue 300. For example, first downtime task 316 can again be “first” in line to be executed should a time slot open in primary task queue 300. However, if first downtime task 316 cannot be completed in the inactive task time slot or the remainder of the completed task time slot, but second downtime task 318 can be completed within those times, second downtime task 318 can be prioritized over first downtime task 316.

However, as illustrated in FIG. 3, first downtime task 316 is determined to fit within the down time of inactive third primary task 308. In embodiments, first downtime task 316 can be extracted from downtime task queue 302 and inserted in primary task queue 300. Third primary task 308 can be removed from the queue, left at the top of the queue, or moved within the queue, depending on the reason for its inactive status. The robot coupled to primary task queue 300 is then instructed to continue executing the tasks in the queue (as shown in FIG. 3, fourth primary task 310). In downtime task queue 302, second downtime task 318 becomes the next task to be queued during down time of primary task queue 300.

In embodiments, retailer robot task scheduling system 104 can comprise one or more data processing engines configured to determine findings based on data returned by autonomous robot 106 during task execution. The findings to be determined can be based on the task definition received from external vendor robot task request system 102 or other sources. In embodiments, findings can include information determined based on image, auditory, or other data returned by autonomous robot 106. For example, where a task definition includes “Verify Pricing,” or “Fix Crooked Labels,” findings can be based on processing image data to determine the location of a pricing label and to detect the displayed price, or angle of the label relative to the shelf. The data processing engines can produce findings using one or more data processing technologies known in the art. In embodiments, data processing engines can be cloud based. In addition to communicating findings to external vendor robot task request system 102, retailer robot task scheduling system 104 can use the findings returned by data processing engines to generate follow-up tasks to add to the task list of one or more robots. This can enable retailer robot task scheduling system 104 to efficiently divide tasks between robots, based on their capabilities. For example, a “Fix Crooked Labels” task can be performed by a instructing a fast robot with high quality image capabilities (for example, a flying robot) to photograph relevant areas of the retail site. The data processing engines can receive the image data, and determine which labels are in, in fact, crooked. One or more robots with label manipulation capabilities can then be dispatched only where needed.

In embodiments, data processing engines can redact, enhance, or otherwise modify data as necessary before it is returned to the requesting vendor. For example, a task for providing images of a vendors product as displayed on a shelf may not include images of products that are situated nearby, which may be a separate task (for which a separate fee could be charged). When images of products are taken, it can be difficult to take an image without including nearby products. Data processing engines can redact the returned images by overwriting or cropping data that is not part of the scope of the task. Conversely, data can be augmented by providing additional information, for example, images or other data gathered can be overlaid with data such as the average number of customers passing a certain section of the store at a particular time.

As illustrated in FIG. 1, external vendor robot task request system 102 is operably coupled to retailer robot task scheduling system 104. However, because of the particular implementation of external vendor robot task request system 102, and particularly, user interface 112, external vendor robot task request system 102 has a one-to-many relationship with retailer robot task scheduling system 104. For example, a single instance of external vendor robot task request system 102 can be coupled to multiple instances of retailer robot task scheduling system 104. For example, each instance of retailer robot task scheduling system 104 can control a single autonomous robot 106, or alternatively, a plurality of robots 106 at a single retail store. In other embodiments, external vendor robot task request system 102 can have a one-to-one relationship with retailer robot task scheduling system 104, wherein a single instance of robot task scheduling engine 120 is configured with multiple queues to allow for organized control of multiple robots at multiple retail stores. In such embodiments, retailer robot task scheduling system 104 is operably coupled to multiple autonomous robots 106 (at least one per retail store).

Referring again to FIG. 1, autonomous robot 106 can comprise communications engine 124, drive mechanism 126, and data capture engine 128. In general, autonomous robot 106 is located in the retail environment and configured to receive the communicated updated robot task list and provide a confirmation once the external vendor robot task is completed. Autonomous robot 106 can be ground-based, capable of flight (e.g., a “drone”), or movable in some other say, such as on a ceiling-mounted track, embedded in a floor or sub-floor structure, mounted to a shelving system or other fixture, or otherwise controllable and/or mobile within or proximate the retail environment.

In particular, communications engine 124 is configured to receive a robot task list from retailer robot task scheduling system 104, and particularly, communications engine 120. Communications engine 124 is further configured to transmit data back to retailer robot task scheduling system 104, such as confirmation that various tasks were completed, along with data supporting those confirmations. Accordingly, communications engine 124 can comprise communications software and transceiver circuitry as described above with respect to communications engine 120. For example, transmitter circuitry can comprise one or more electronic elements configured to transmit and receive data related to system 100. For example, wireless transceiver circuitry can be configured for radio frequency (RF) communications, WIFI communications, BLUETOOTH communications, cellular communications, or near-field communications (NFC). Wired transceiver circuitries can likewise be utilized, such as CAT-5 and CAT-6. In embodiments, communication engine 124 is configured to receive TCP/IP protocol communications. Vendor or retailer-based task commands or other commands can be provided within the TCP/IP protocol network packets.

In some embodiments, communications engine 124 is configured to communicate directly with external vendor robot task request system 102, or hardware operated by individual vendor users. For example, confirmation data can be sent to a requester of the external vendor robot task by an email communication, a text message communication, a report, or a presentation in user interface 112. Therefore, in embodiments (not shown), autonomous robot 106 can communicate directly with external vendor robot task request system 102.

Drive mechanism 126 comprises a drive subassembly for physically moving autonomous robot 106 and a controller for operating the drive subassembly. Drive subassembly comprises any suitable combination of motor, gears, wheels, and interconnects to power and move autonomous robot 106. The controller is configured command the drive assembly to move autonomous robot 106 to various locations around the store and to perform various tasks once moved or while moving, according to the received robot task list.

Data capture engine 128 is configured to capture visual, photographic, image, positional, sensor (e.g., temperature, humidity, light, sound) or other data near autonomous robot 106. For example, data capture engine 128 can comprise a digital camera for taking a picture of a display or retail product. In an embodiment, the confirmation from autonomous robot 106 comprises a photograph related to the completed external vendor robot task. For example, a vendor user task can include verifying that an end cap display is displayed correctly. Autonomous robot 106, using data capture engine 128, can obtain a photograph of the end cap display for transmission back to the vendor user requesting the task. In another example, data capture engine can comprise a temperature sensor to sense the temperature of a cooler, freezer, or other environment in which a product might be stored or displayed. A vendor user task can include checking a temperature of a display, and autonomous robot 106, using data capture engine 128, can sense the temperature of the display and transmit the sensed temperature data back to the vendor user requesting the task.

In another example, data capture engine 128 can comprise a positional component, such as a Global Positioning System (GPS) receiver, RF receiver, or NFC receiver. In other embodiments, data capture engine 128 can comprise other sensors to obtain data related to the retail store, such as 2D or 3D scanners, distance sensors, temperature sensors, or aroma sensors.

In an embodiment (not shown), autonomous robot 106 can further comprise a battery for powering the components of autonomous robot 106 such as communications engine 124, drive mechanism 126, and data capture engine 128.

As mentioned above, commands other than vendor or retailer-based task commands can be received and implemented by autonomous robot 106. For example, communication engine 124 can receive, implement, and correspondingly reply to commands such as “give me info on the robot,” in which hardware, software, and/or status information on the robot is communicated back in response to the received command. In another example, communication engine 124 can receive a sensor reading command. In response, autonomous robot can read from its one or more sensors and respond to the command with sensor data. In another example, communication engine 124 can receive a “remap the store” command. The robot can then utilize drive mechanism 126 and data capture engine 128 to traverse the store and capture data that can be assembled into a map or other positional data for the store. In an embodiment, autonomous robot 106 can utilize an existing stored map to more efficiently traverse the store and modify the existing map to generate a new map. In another example, communication engine 124 can receive a “go charge” command. In response, autonomous robot 106 can utilize drive mechanism 126 to position autonomous robot 106 proximate a charging station or charging device in order to charge a battery of autonomous robot 106.

In an embodiment, communication engine 124 is configured to communicate with other autonomous robots 106 (and other corresponding communications engines 124 of those robots). For example, if a first robot is behind on task assignments, or if the first robot has been assigned too many tasks, the first robot can assign one or more tasks to a second robot using their respective communication engines. In another example, if the network between robot task scheduling system 104 and autonomous robot(s) 106 is disrupted, the autonomous robot(s) 106 can themselves distribute tasks to other robots until the network is corrected and robot task scheduling system 104 can reestablish task assignments.

The format and type of messages communicated to autonomous robots 106 can vary based on the capabilities of each autonomous robots 106. For example, certain autonomous robots 106 can have sophisticated routing and navigational systems and/or be trained on the layout of a particular retail site. Such robots can be provided high-level commands such as “Take photo of Section #n.” Other autonomous robots 106 can have more rudimentary navigation systems such that robot task scheduling engine 122 needs to provide detailed commands such as “Move forward 100 meters, turn right, take a photo at 50 centimeters from the ground.” Robot task scheduling engine 122 can be configured to support multiple robot configuration levels and modify the commands provided as required.

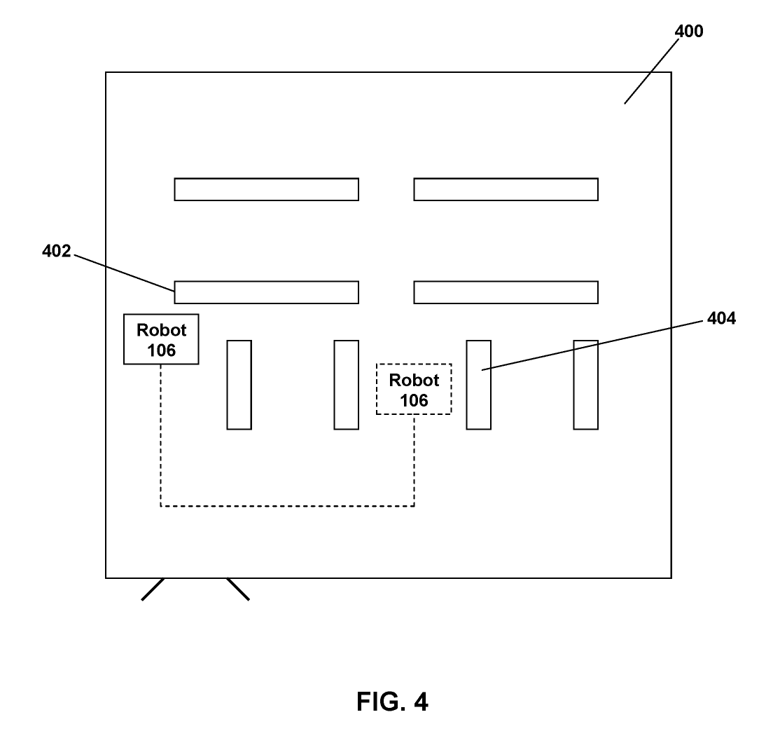

Referring to FIG. 4, a diagram of a retail store 400 in which components of system 100 of FIG. 1 can be deployed is depicted, according to an embodiment. In the retail store 400 illustration, a number of shelving and end cap displays are depicted, including an end cap display 402 and a shelved item 404. End cap display 402 can comprise a display set up by the retailer within the retailer's store according to specifications from a first vendor. Shelved item 404 can comprise a retail item for sale within the retailer's store at a price stipulated by a second vendor.

In an embodiment, the first vendor can add a task to the robot task list associated with autonomous robot 106. In particular, the first vendor task can include verifying that end cap display 402 is set up correctly. Similarly, the second vendor can add a task to the robot task list associated with autonomous robot 106 that is queued in the task list to be performed after the first vendor task. The second vendor task can include verifying that shelved item 404 is priced correctly. As instructed, autonomous robot 106 can execute the tasks in the task list as directed by, for example, robot task scheduling system 104.

Autonomous robot 106 can first execute the first vendor task by positioning itself proximate end cap display 402 and using data capture engine 128 to take a picture of end cap display 402. Autonomous robot 106 can then execute the second vendor task by positioning itself proximate shelved item 404. As depicted, autonomous robot 106 can move from the location of end cap display 402 along the dotted line to the location of shelved item 404. Autonomous robot 106 can take any number of paths within the store, including the most direct route as mapped out in FIG. 4. In embodiments, the path may avoid a group of customers sensed by data capture engine 128. Autonomous robot 106 can use data capture engine 128 to scan a price for shelved item 404. The picture of end cap display 402 can be sent to the first vendor as evidence that the first task was completed. Likewise, the price scan of shelved item 404 can be sent to the second vendor as evidence that the second task was completed.

The robot, pricing and other features of the system also can be adaptable to real-time conditions in the store. For example, the robot can be programmed algorithms to handle a situation in which it cannot access an area to complete a task because customers are present or the area is otherwise inaccessible. The robot may have a pre-defined wait-time (e.g., 5 minutes) after which it moves on to another tasks and repositions the first task in its queue. Real-time information about these and other events impacting robot completion of vendor tasks also can be provided to the vendor. In some embodiments, the robot can be equipped with a real-time camera or other tracking system such that the vendor can view the robot or the retail store in real-time as tasks are carried out.

Real-time event processing can be implemented with Apache Storm, Spark, or Nifi, for example. In an embodiment, redundant queued messaging systems such as Apache Kafka can be further utilized. For example, robot task scheduling engine 122 can further comprise a real-time event processing sub-system. The real-time event processing sub-system can be configured to process messages as fast as possible on the central end of the system, while the autonomous robot can execute REST web services or Remote Procedure Calls (RPC) using HTTP/2 protocols, such as gRPC for communication with the real-time event processing sub-system.

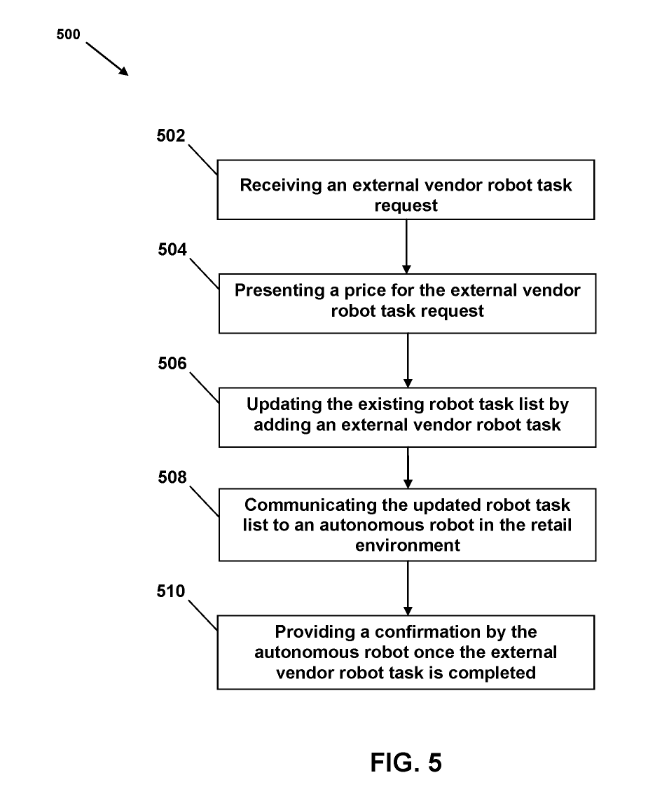

Referring to FIG. 5, a flowchart of a method 500 for managing an autonomous robot in a retail environment is depicted, according to an embodiment. Method 500 can be implemented or carried out by embodiments of system 100, such as external vendor robot task request system 102, retailer robot task scheduling system 104, and autonomous robot 106. Reference to FIG. 1 and system 100 is made throughout the following description of FIG. 5 for ease of explanation.

At 502, an external vendor robot task request is received. In embodiments, as described above, the external vendor robot task request can include a task definition and a desired task timeframe. For example, user interface 112 can receive the external vendor robot task request.

At 504, a price is presented for the external vendor robot task request. In an embodiment, user interface 112 can present the price. In embodiments, the price can be related to, for example, the task definition, the desired task timeframe, or an existing robot task list.

In another embodiment, presenting at 504 can further comprise presenting a first price for adding the external vendor robot task to a downtime task queue, and presenting a second price higher than the first price for adding the external vendor robot task to a primary task queue. In another embodiment, presenting at 504 can further comprise presenting an external vendor robot task subscription offer to a vendor user, wherein the subscription offer comprises a price bundle for multiple external vendor robot tasks. In another embodiment, presenting at 504 can further comprise presenting a set of predefined external vendor robot tasks in user interface 112, wherein the received external vendor robot task request is one selected from the presented set of predefined external vendor robot tasks. In another embodiment, presenting at 504 can further comprise presenting a set of predefined desired task timeframes in a user interface such as user interface 112, wherein the desired task timeframe is one selected from a presented set of predefined external vendor robot task timeframes.

At 506, the existing robot task list is updated by adding an external vendor robot task to the existing robot task list. For example, robot task scheduling engine 122 can update the existing robot task list to generate an updated robot task list. In embodiments, the robot task list can be sorted or otherwise prioritized to generate the updated robot task list according to the task definition, the desired task timeframe, or at least one task already on the existing robot task list.

In an embodiment, wherein the existing robot task list comprises a primary task queue and a downtime task queue such as in FIG. 3, and wherein autonomous robot 106 is configured to carry out tasks in the downtime task queue when the primary task queue is completed or inactive, updating at 506 can comprise adding the external vendor robot task to the downtime task queue.

At 508, the updated robot task list is communicated to an autonomous robot in the retail environment. For example, communications engine 120 of retailer robot task scheduling system 104 can transmit the updated robot task list to communications engine 124 of autonomous robot 106. Once the updated robot task list is communicated to autonomous robot 106, autonomous robot 106 can execute the tasks in the updated robot task list. In embodiments, method 500 can further comprise communicating the updated robot task list to personnel of the retail environment. Retail personnel can then monitor or be aware of planned robot activity.

At 510, a confirmation is provided by the autonomous robot once the external vendor robot task is completed. For example, data capture engine 128 of autonomous robot 106 can photograph a portion of the retail environment specified by the robot task and transmit this data to be received by the external vendor user. In embodiments, communications engine 124 of autonomous robot 106 is configured to send a confirmation to a requester of the external vendor robot task by at least one of an email communication, a text message communication, a report, or a presentation in user interface 112.

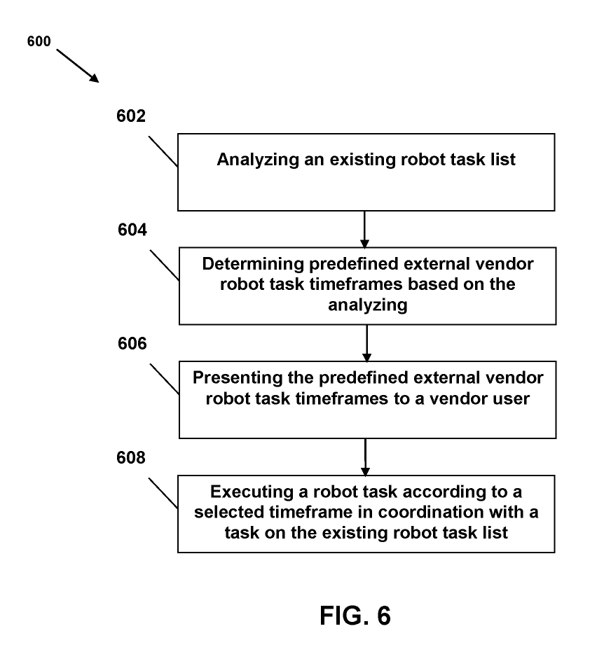

Referring to FIG. 6, a flowchart of a method 600 for analyzing a robot task list for an autonomous robot in a retail environment is depicted, according to an embodiment. In embodiments, method 600 can be used in combination with method 500. For example, method 600 can be implemented to supplement 502 and 504 as a vendor user communicates an external vendor robot task request to systems described herein.

At 602, an existing robot task list is analyzed. For example, robot task scheduling engine 122 can analyze a robot task list stored within memory 118 on retailer robot task scheduling system 104.

At 604, predefined external vendor robot task timeframes are determined based on the analyzing at 602. For example, a set of external vendor robot task timeframes can be generated based on the current tasks in the existing robot task list. Time frames can be generated based on expected completion of current tasks, potential scheduling piggybacking, or location information.

At 606, the predefined external vendor robot task timeframes are presented to the vendor user. For example, the external vendor robot task timeframes can be presented to a vendor user with user interface 112 as potential timeframes in which a vendor user task can be completed. Relative coordination with current tasks in the existing robot task list can thus be taken into account when presenting the potential timeframes. This information can optionally be displayed to the user. For example, the user can be notified that autonomous robot 106 will be in a location proximate a vendor user task.

At 608, a robot task is executed according to a selected timeframe in coordination with a task on the existing robot task list. For example, the vendor user can add a new vendor task to the existing robot task list that uses an existing task as context (location, timing, etc.) This new vendor task can then be executed by autonomous robot 106.

Thus, embodiments allow for a number of benefits for both retailers and vendors. Systems and methods described herein can reduce vendor costs and improve efficiency and accuracy of task completion. Systems and methods can also allow retailers to defray or share robot-related costs with vendors, while still managing robot priorities and availability. Robot performance can be easily monitored by vendors and/or the retailer to determine status. Robots can be deployed to areas or for tasks that are undesirable or infeasible for humans to perform, such as extended monitoring in refrigerated environments. Additionally, the availability of robots for vendor tasks can be attractive to vendors when selecting which retailers to offer their products. Embodiments of the present disclosure provide vendors with additional flexibility in scheduling monitoring tasks, both in regard to the availability of robots, and the ability to quickly prioritize tasks that are of particular value.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A system for managing an autonomous robot in a retail environment comprising:
an external vendor robot task request system comprising a user interface configured to accept an external vendor robot task request having a task definition and a desired task timeframe and present a price for the external vendor robot task request related to at least one of the task definition, the desired task timeframe, or an existing robot task list; and
a retailer robot task scheduling system configured to:
receive at least one internal retailer-defined task having a task definition and a task timeframe and add the at least one internal retailer-defined task to the existing robot task list according to the task timeframe,
receive the external vendor robot task request after the presented price for the external vendor robot task request has been accepted and update the existing robot task list to include an external vendor robot task based on the external vendor robot task request, wherein the updated robot task list is sorted according to at least one of task definitions, desired task timeframes, price, or at least one task already on the existing robot task list, and
communicate the updated robot task list; and
an autonomous robot located in the retail environment and configured to receive the communicated updated robot task list and provide a confirmation once the external vendor robot task is completed.

2. The system of claim 1, wherein the existing robot task list comprises a primary task queue and a downtime task queue, wherein the autonomous robot is configured to carry out tasks in the downtime task queue when the primary task queue is completed or inactive, and wherein the external vendor robot task is added to the downtime task queue.

3. The system of claim 2, wherein the external vendor robot task request system is configured to present a first price for adding the external vendor robot task to the downtime task queue and a second price higher than the first price for adding the external vendor robot task to the primary task queue.

4. The system of claim 1, wherein the user interface of the external vendor robot task request system is configured to present an external vendor robot task subscription offer to a vendor user, wherein the subscription offer comprises a price bundle for multiple external vendor robot tasks.

5. The system of claim 1, wherein the external vendor robot task request is selected from a set of predefined external vendor robot tasks presented in the user interface.

6. The system of claim 1, wherein the desired task timeframe is selected from a set of predefined external vendor robot task timeframes presented in the user interface.

7. The system of claim 6, wherein the retailer robot task scheduling system is configured to determine the predefined external vendor robot task timeframes based on a current robot task list.

8. The system of claim 7, wherein the retailer robot task scheduling system is configured to analyze the existing robot task list and offer a predefined external vendor robot task timeframe based on a result of the analysis being that the autonomous robot can carry out the requested external vendor task in coordination with an internal retailer-defined task already on the existing robot task list.

9. The system of claim 8, wherein the retailer robot task scheduling system determines that the autonomous robot can carry out the requested external vendor task in coordination with the internal retailer-defined task already on the existing robot task list if the requested external vendor task is in an area of the retail environment that is the same as or proximate to an area of the retail environment of the internal retailer-defined task already on the existing robot task list.

10. The system of claim 1, wherein the user interface of the external vendor robot task request system is configured to present real-time availability of the autonomous robot.

11. The system of claim 1, wherein the confirmation comprises a photograph related to the completed external vendor robot task.

12. The system of claim 1, wherein the confirmation is sent to a requester of the external vendor robot task by at least one of an email, a text message, a report, or a presentation in the user interface.

13. The system of claim 1, wherein the robot task scheduling system is configured to communicate the updated robot task list to at least one of the autonomous robot or personnel of the retail environment.

14. A method for managing an autonomous robot in a retail environment comprising:
receiving an external vendor robot task request having a task definition and a desired task timeframe;
presenting a price for the external vendor robot task request related to at least one of the task definition, the desired task timeframe, or an existing robot task list;
updating the existing robot task list by adding an external vendor robot task based on the external vendor robot task request according to at least one of the task definition, the desired task timeframe, or at least one task already on the existing robot task list;
communicating the updated robot task list to an autonomous robot in the retail environment; and
providing a confirmation by the autonomous robot once the external vendor robot task is completed.

15. The method of claim 14, wherein the providing comprises providing a photograph related to the completed external vendor robot task.

16. The method of claim 14, wherein the providing further comprises sending the confirmation to a requester of the external vendor robot task by at least one of an email, a text message, a report, or a presentation in the user interface.

17. The method of claim 14, further comprising communicating the updated robot task list to personnel of the retail environment.

18. The method of claim 14, wherein the existing robot task list comprises a primary task queue and a downtime task queue, wherein the autonomous robot is configured to carry out tasks in the downtime task queue when the primary task queue is completed or inactive, and wherein the updating comprises adding the external vendor robot task to the downtime task queue.

19. The method of claim 18, wherein the presenting comprises presenting a first price for adding the external vendor robot task to the downtime task queue, and presenting a second price higher than the first price for adding the external vendor robot task to the primary task queue.

20. The method of claim 14, wherein the presenting further comprises presenting an external vendor robot task subscription offer to a vendor user, wherein the subscription offer comprises a price bundle for multiple external vendor robot tasks.

21. The method of claim 14, further comprising presenting a set of predefined external vendor robot tasks presented in a user interface, wherein the received external vendor robot task request is one selected from the presented set of predefined external vendor robot tasks.

22. The method of claim 14, further comprising presenting a set of predefined desired task timeframes in a user interface, wherein the desired task timeframe is one selected from the presented set of predefined external vendor robot task timeframes.

23. The method of claim 22, further comprising determining the predefined external vendor robot task timeframes based on a current robot task list.

24. The method of claim 23, further comprising analyzing the existing robot task list and offering a predefined external vendor robot task timeframe based on a result of the analyzing being that the autonomous robot can carry out the requested external vendor task in coordination with a task already on the existing robot task list.

25. A system for managing an autonomous robot in a retail environment comprising:
an external vendor robot task request system comprising a user interface configured to accept an external vendor robot task request having a task definition including a requested data item and a desired task timeframe and present a price for the external vendor robot task request related to at least one of the task definition, the desired task timeframe, or an existing robot task list; and
a retailer robot task scheduling system configured to:
receive at least one internal retailer-defined task having a task definition and a task timeframe and add the at least one internal retailer-defined task to the existing robot task list according to the task timeframe,
receive the external vendor robot task request after the presented price for the external vendor robot task request has been accepted and update the existing robot task list to include an external vendor robot task based on the external vendor robot task request, wherein the updated robot task list is sorted according to at least one of task definitions, desired task timeframes, price, or at least one task already on the existing robot task list, and
communicate the updated robot task list;
an autonomous robot located in the retail environment and configured to receive the communicated updated robot task list and provide a confirmation including a gathered data item once the external vendor robot task is completed,
a data processing engine configured to modify the gathered data item to meet one or more parameters of the requested data item and provide the modified data item to the external vendor robot task request system.
